(19) United States
(12) Patent Application Publication
(10) Pub. No.: US 2026/0168658 A1
(43) Pub. Date: Jun. 18, 2026

(54) MULTI-PURPOSE LAMP

(71) Applicant: Jiangmen Lidu Lighting Co., Ltd., Jiangmen (CN)

(72) Inventors: GUODU XU, Jiangmen (CN); JIANRONG YANG, Jiangmen (CN)

(21) Appl. No.: 18/983,298

(22) Filed: Dec. 16, 2024

(51) Int. Cl. F21V 21/108; F21V 5/04; F21V 17/00; F21V 17/08; F21V 17/12; F21V 17/16; F21V 19/00; F21V 21/08; F21V 23/00; F21Y 113/13

(52) U.S. Cl. CPC F21V 21/108; F21S 4/10; F21V 5/048; F21V 17/005; F21V 17/08; F21V 17/12; F21V 17/16; F21V 19/0045; F21V 21/0824; F21V 23/002; F21V 23/005; F21Y 2113/13

(57) ABSTRACT

A multi-purpose lamp is provided, which includes an upper shell, a lower shell, a reflective cup component, a connection wire, a control module, a lens, and a ground plug; the control module includes a PCBA board, and the PCBA board is provided with a light-emitting component and a control chip; the upper shell is connected to the lower shell, the control module is located in the upper shell; the reflective cup component corresponds to the light-emitting component; the connection wire is connected to the control module and transmits power and signals. The lower shell is provided with a through-hole. By a design of the multi-purpose lamp and a cooperation of the through hole and the ground plug, the multi-purpose lamp can be changed to a stake lamp, so that the multi-purpose lamp is no longer solely applied to eaves.

### TECHNICAL FIELD

The present disclosure relates to the field of lamp technologies, and in particular, to a multi-purpose lamp.

### BACKGROUND

Eave lamps are lighting fixtures that can be installed on various buildings, and their shapes and sizes are varied. Corresponding kits can be selected according to an actual need and can be plugged into ground or fixed to a wall with a screw and 3M glue.

The existing eaves lamps have relatively limited functionality and cannot meet the current usage needs, so there is an improvement in practical use.

### SUMMARY

The present application aims to solve at least one of the above-mentioned technical problems by providing a multi-purpose lamp to ensure that it meets the functional limitations of existing eaves lamps.

The multi-purpose lamp provided in the present application adopts the following technical solution.

A multi-purpose lamp, including an upper shell, a lower shell, a reflective cup component, a connection wire, and a control module;
the control module includes a printed circuit board assembly, PCBA board, and the PCBA board is provided with a light-emitting component and a control chip;
the upper shell is connected to the lower shell, and the control module is located in the upper shell; the reflective cup component corresponds to the light-emitting component; the connection wire is connected to the control module and transmits power and signals.

In some embodiments of the present application, the upper shell is provided with a reinforcing rib, a positioning hole, and a wire slot; the lower shell is provided with a positioning column, a wiring trough, and a through hole; the reflective cup component includes a reflective cup; the connection wire includes an electric wire, a data wire, and a solder pad; the PCBA board is provided with a positioning groove;
a shape of the PCBA board corresponds to an internal shape of the upper shell; the reinforcing rib is matched with the positioning groove;
the positioning column is matched with the positioning hole to facilitate a connection between the upper shell and the lower shell.

In some embodiments of the present application, the multi-purpose lamp is capable of being connected to a router, and the multi-purpose lamp is connected to an APP through the router;
the multi-purpose lamp further includes a controller and a driving power supply.

In some embodiments of the present application, the control chip is provided with a high-voltage driving module with an OUT port, a zeroing code decoding module, an over temperature protection module, a constant current driving module, and a zeroing code data shaping output module;
the control chip is a FW1906 chip;
the light-emitting component is a 5050 packaged RGBCW LED light emitting chip, and the LED light emitting chip is packaged with 6 strings of warm white light, 6 strings of cool white light, 6 strings of red light, 6 strings of green light, and 6 strings of blue light.

In some embodiments of the present application, the multi-purpose lamp further includes a lens and a ground plug, the ground plug is connected to the lower shell through the through hole; the lens is connected to the upper shell.

In some embodiments of the present application, the lens is provided with a transparent part and a lens connection part; the lens connection part is provided with a connection clamp block; the connection clamp block is configured to connect the upper shell.

In some embodiments of the present application, the transparent part is spherical, cylindrical, a star-shape, rectangular, or pumpkin-shape;
the transparent part is provided with a refractive part, and the refractive part is conical in shape; a surface of the transparent part is coated with a reflective coating, which renders light evenly reflected to the ground.

In some embodiments of the present application, the multi-purpose lamp further includes a fixing element, where the fixing element is provided with a fixing element clamp block, a fixing hole, a circuit channel, and a heat dissipation hole.

In some embodiments of the present application, the fixing element is L-shaped as a whole.

In summary, the present application includes at least one beneficial technical effect as follows.
1. The use of a fixing element can further facilitate the flexible installation of the multi-purpose lamp by a user.
2. A cooperation design of the through hole and the ground plug can change the multi-purpose lamp into a stake lamp, so that the multi-purpose lamp is no longer solely used on eaves.
3. Enhance the emission effect of light through the lens.

### BRIEF DESCRIPTION OF DRAWINGS

FIG. 1 is a first schematic structural diagram of a multi-purpose lamp according to an embodiment of the present application.

FIG. 2 is a first schematic diagram of an internal structure of the multi-purpose lamp according to an embodiment of the present application.

FIG. 3 is a second schematic diagram of the internal structure of the multi-purpose lamp according to an embodiment of the present application.

FIG. 4 is a third schematic diagram of the internal structure of the multi-purpose lamp according to an embodiment of the present application.

FIG. 5 is a schematic structural diagram of a fixing element in an embodiment of the present application.

FIG. 6 is a working schematic diagram of the fixing element in an embodiment of the present application.

FIG. 7 is a second schematic structural diagram of the multi-purpose lamp according to an embodiment of the present application.

FIG. 8 is a schematic structural diagram of a ground plug in an embodiment of the present application.

FIG. 9 is a schematic structural diagram of a lens in a first embodiment of the present application.

FIG. 10 is a working schematic diagram of a stake lamp in an embodiment of the present application.

FIG. 11 is a schematic structural diagram of the lens in a second embodiment of the present application.

FIG. 12 is a working schematic diagram of the lens shown in FIG. 11.

FIG. 13 is a schematic structural diagram of the lens in a third embodiment of the present application.

FIG. 14 is a schematic structural diagram of the lens in a fourth embodiment of the present application.

FIG. 15 is a schematic structural diagram of the lens in a fifth embodiment of the present application.

FIG. 16 is a system schematic diagram of the multi-purpose lamp according to an embodiment of the present application.

FIG. 17 is a schematic diagram of data format of a FW1906 chip in an embodiment of the present application.

FIG. 18 is a schematic diagram of cascaded data format of the FW1906 chip in an embodiment of the present application.

FIG. 19 is an application schematic diagram of the FW1906 chip in an embodiment of the present application.

FIG. 20 is a protocol schematic diagram of the FW1906 chip of the present application.

Numeral reference: 1—upper shell; 11—reinforcing rib; 12—positioning hole; 13—wire slot; 2—lower shell; 21—positioning column; 22—wiring trough; 23—through hole; 3—reflective cup component; 31—reflective cup; 4—screw; 5—connection wire; 6—control module; 61—PCBA board; 611—light—emitting component; 612—control chip; 613—positioning groove; 7—lens; 71—transparent part; 711—refractive part; 72—lens connection part; 721—connection clamp block; 8—fixing element; 81—fixing element clamp block; 82—fixing hole; 83—circuit channel; 84—heat dissipation hole; 9—ground plug; 91—connection part; 911—protruding part; 912—connection main body; 92—ground plug part.

### DESCRIPTION OF EMBODIMENTS

The following will provide a clear and complete description of the technical solution in the embodiments of the present application, combined with the accompanying drawings. Obviously, the described embodiments are only a part of the embodiments of the present application, not all of them. Based on the embodiments in the present application, all other embodiments obtained by those skilled in the art without creative work are within the protection scope of the present application.

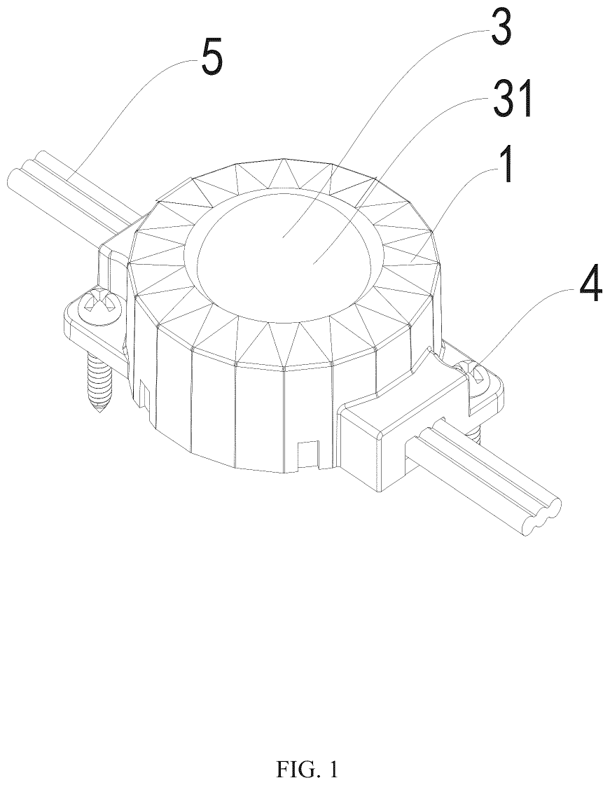

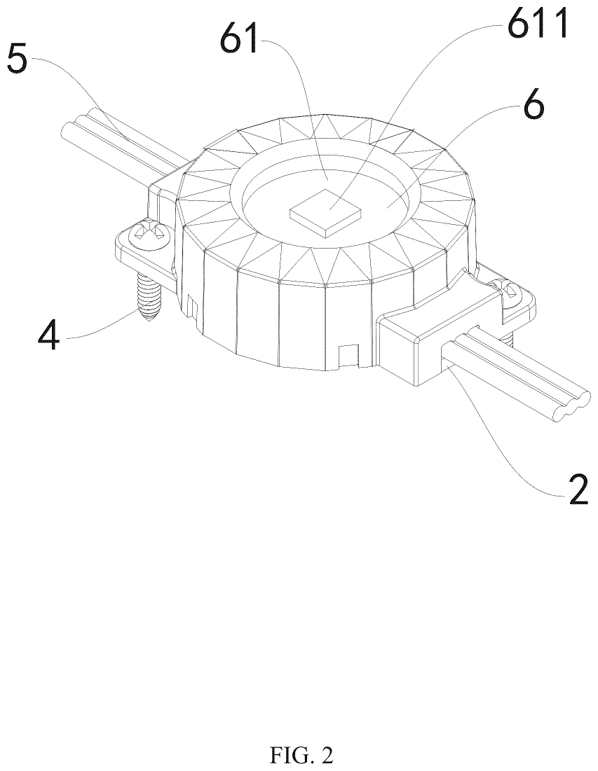

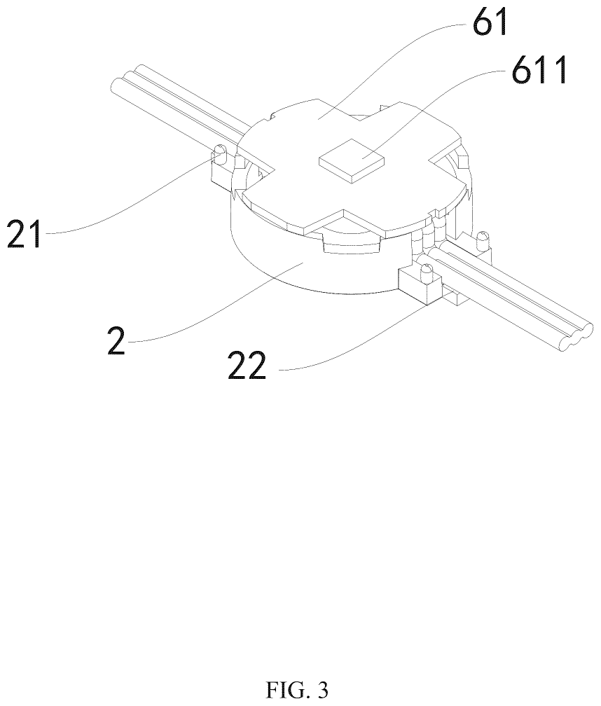

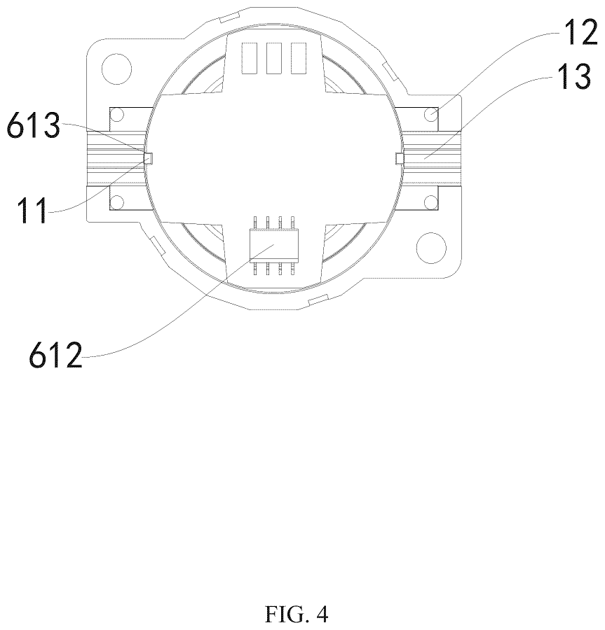

The present embodiment discloses a multi-purpose lamp. Referring to FIGS. 1-4, the multi-purpose lamp may include an upper shell 1, a lower shell 2, a reflective cup component 3, a screw 4, a connection wire 5, and a control module 6.

The control module 6 may include a printed circuit board assembly, PCBA board 61, the PCBA board 61 may be provided with a light-emitting component 611 and a control chip 612.

The upper shell 1 is connected to the lower shell 2, and the control module 6 is located in the upper shell 1. The reflective cup component 3 is located on the control module 6, in an implementation mode, the reflective cup component 3 corresponds to the light-emitting component 611. The connection wire 5 is connected to the control module 6, and the connection wire 5 transmits power and signals. The screw 4 is inserted into the upper shell 1 for easy fixation of the multi-purpose lamp.

It can be understood that double-sided tape can be pasted on the lower shell 2 to facilitate the fixation of the multi-purpose lamp.

Please further refer to FIGS. 1-4 and 7. It can be understood that the upper shell 1 may be provided with a reinforcing rib 11, a positioning hole 12, and a wire slot 13. The lower shell 2 can be provided with a positioning column 21, a wiring trough 22, and a through hole 23. The reflective cup component 3 may include a reflective cup 31. The connection wire 5 may include an electric wire a data wirer, and a solder pad. In an implementation mode, the electric wire transmits power, the data wire transmits data, and the solder pad is used to connect another multi-purpose lamp. Multiple multi-purpose lamps can be connected through the solder pad. The PCBA board 61 can also be provided with a positioning groove 613.

A shape of the PCBA board 61 corresponds to an interior shape of the upper shell 1, so that the PCBA board 61 is just clamped into the interior of the upper shell 1. Besides that, the upper shell 1 is reinforced by the reinforcing rib 11, the reinforcing rib 11 also cooperates with the positioning groove 613 to assist in the positioning of the PCBA board 61, so that a position of the light-emitting component 611 on the PCBA board 61 corresponds to a center of the reflective cup 31.

The wire slot 13 and the wiring trough 22 are used to comb the connection wire 5.

The positioning column 21 is matched with the positioning hole 12 to facilitate a connection between the upper shell 1 and the lower shell 2. The connection between the upper shell 1 and the lower shell 2 can be secured by a punch press.

It can be understood that in order to further enhance a fixing effect and prevent moisture and dust, glue can be added through the through hole 23 to achieve the effect of strengthening the fixing and preventing moisture and dust. The glue can be an AB glue.

It can be understood that the reflective cup 31 can also be provided with an anti-adhesive strip, the anti-adhesive strip is located inside the reflective cup 31. The anti-adhesive strip is used to prevent moisture, glue, and dust from entering the reflective cup 31 and affecting a luminous effect of the light-emitting component 611.

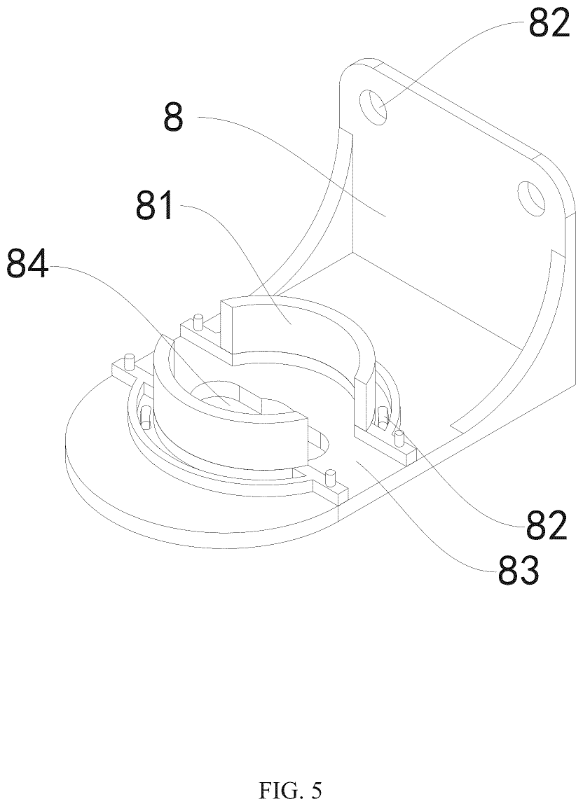

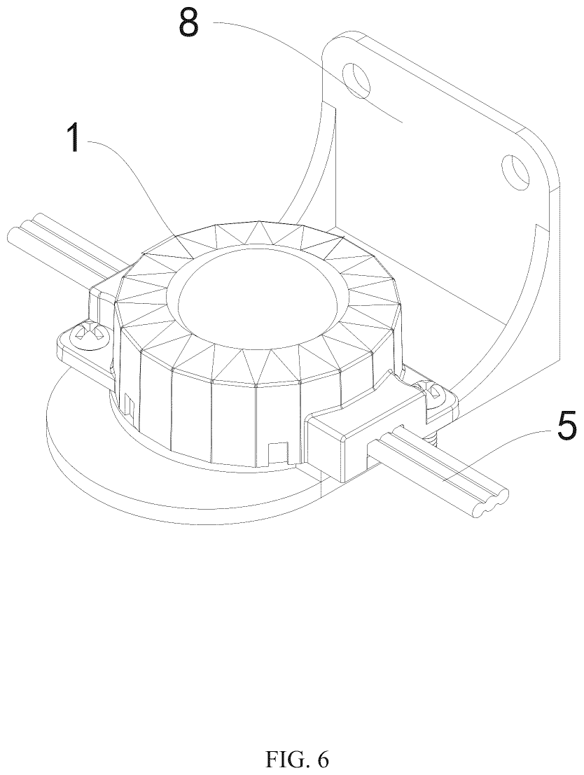

Please further refer to FIGS. 5 and 6, it can be understood that the multi-purpose lamp may further include a fixing element 8. The fixing element 8 is connected to the lower shell 2. The function of the fixing element 8 is to further facilitate the fixation of the multi-purpose lamp. Through the fixing element 8, a user can install the multi-purpose lamp more flexibly.

The fixing element 8 can be provided with a fixing element clamp block 81, a fixing hole 82, a circuit channel 83, and a heat dissipation hole 84. The fixing element clamp block 81 is used to fix the upper shell 1, the circuit channel 83 is used to comb the connection wire 5, and the heat dissipation hole 84 is used for heat dissipation. The fixing hole 82 facilitates the fixation of the fixing element 8.

It can be understood that the fixing element 8 is roughly L-shaped as a whole.

It can be understood that this embodiment does not limit a position and a posture of the fixing element 8 when fixed.

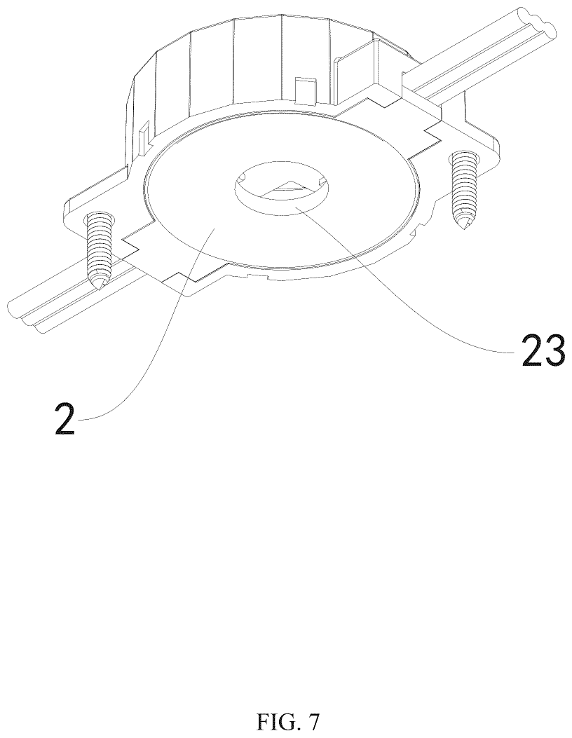

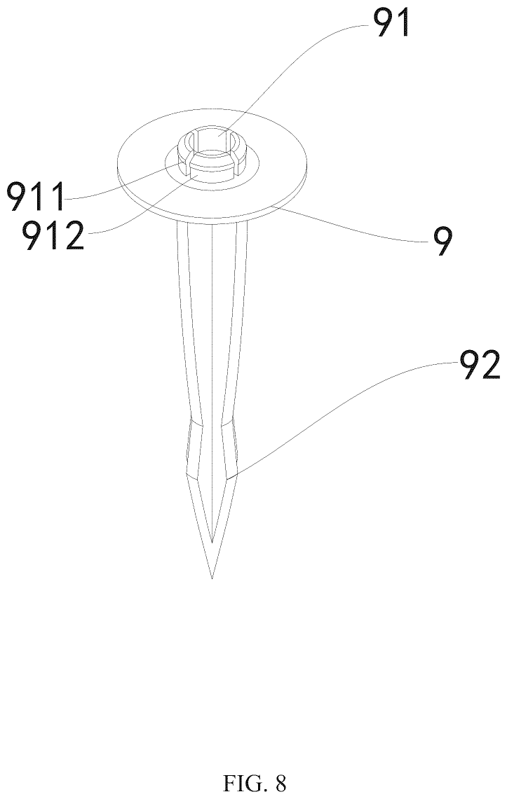

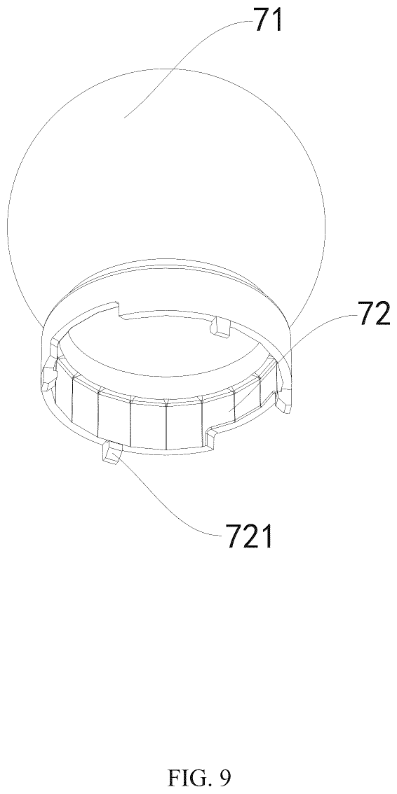

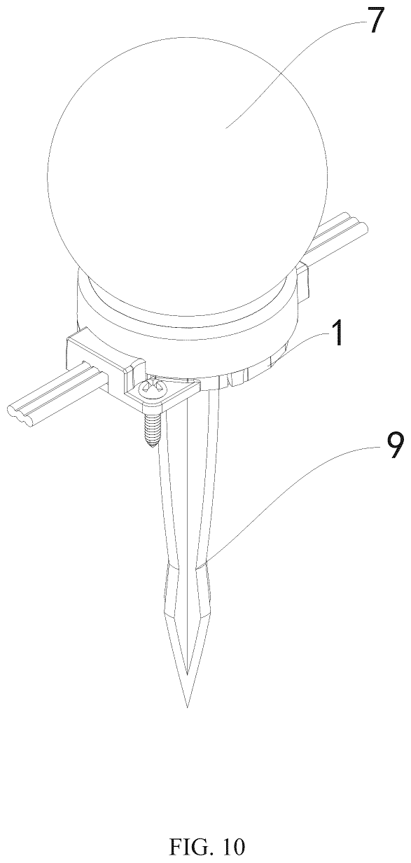

Please further refer to FIG. 7-10, it can be understood that the multi-purpose lamp may also include a lens 7 and a ground plug 9. The lens 7 is sleeved on the upper shell 1. The through hole 23 can also be used to connect the ground plug 9.

The ground plug 9 can be provided with a connection part 91 and a ground plug part 92. The connection part 91 may be provided with a protruding part 911 and a connection main body 912. The connection part 91 is connected to the ground plug part 92, and the connection part 91 has elasticity. The connection part 91 passes through the through hole 23, and the protruding part 911 contacts the through hole 23, thereby connecting the ground plug 9 to the lower shell 2.

Through a cooperation design of the through hole 23 and the ground plug 9, the multi-purpose lamp can be transformed into a stake lamp, so that the multi-purpose lamp is no longer solely applied to eaves.

The lens 7 can be provided with a transparent part 71 and a lens connection part 72. The lens connection part 72 is provided with a connection clamp block 721. The connection clamp block 721 is used to connect the upper shell 1.

The transparent part 71 is spherical in shape, and a refractive effect of light is enhanced by the lens 7, which renders the multi-purpose lamp have more excellent refractive effect when used as a stake lamp.

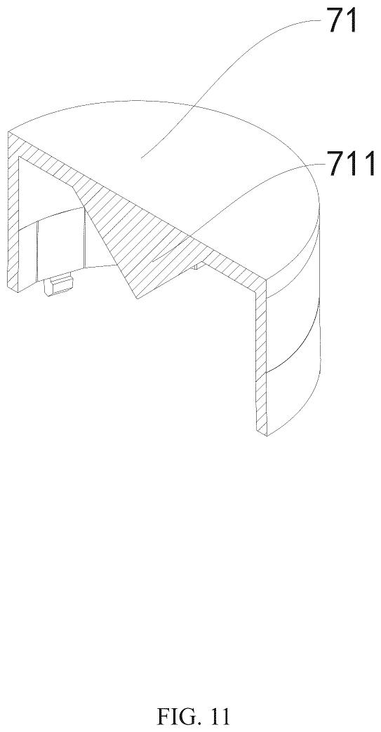

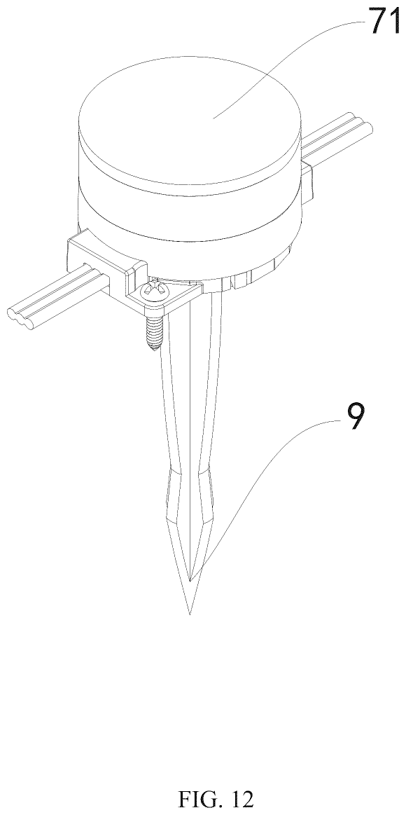

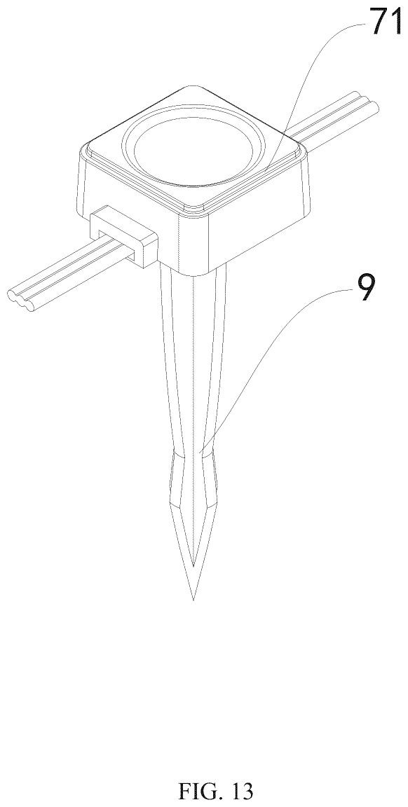

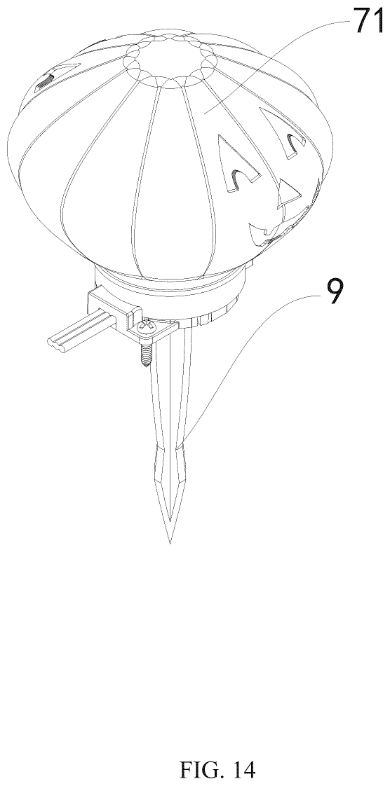

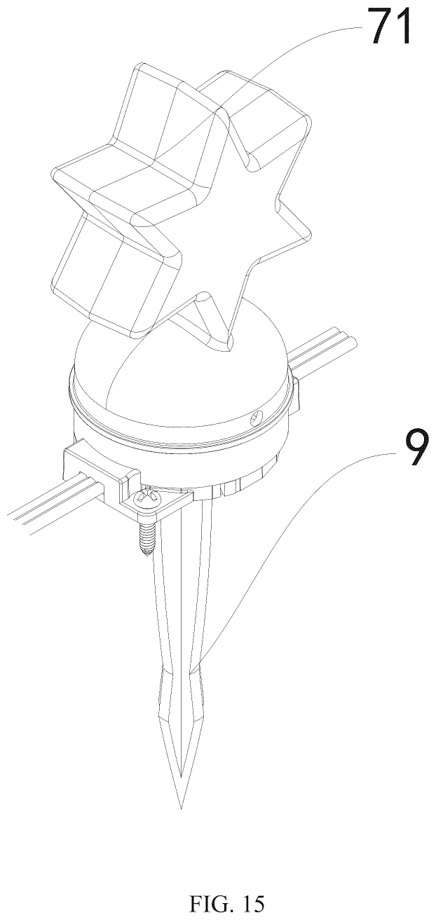

Please further refer to FIGS. 11-15, it can be understood that the transparent part 71 can be cylindrical. The transparent part 71 may be provided with a refractive part 711, and the refractive part 711 may be conical in shape. By a shape design of the refractive part 711, the refractive effect of light is enhanced, which renders the multi-purpose lamp have more excellent refractive effect when used as a stake lamp.

It can be understood that a surface of the transparent part 71 can be coated with a reflective coating to render the light more evenly reflected to the ground.

It can be understood that the transparent part 71 can be designed with different shapes as needed, so that when the multi-purpose lamp is used as a stake lamp, it emits light and shadow with a shape of an object. For example, the transparent part 71 can be in a shape of a star, a rectangle, or a pumpkin, allowing the multi-purpose lamp to emit corresponding shapes of light and shadow.

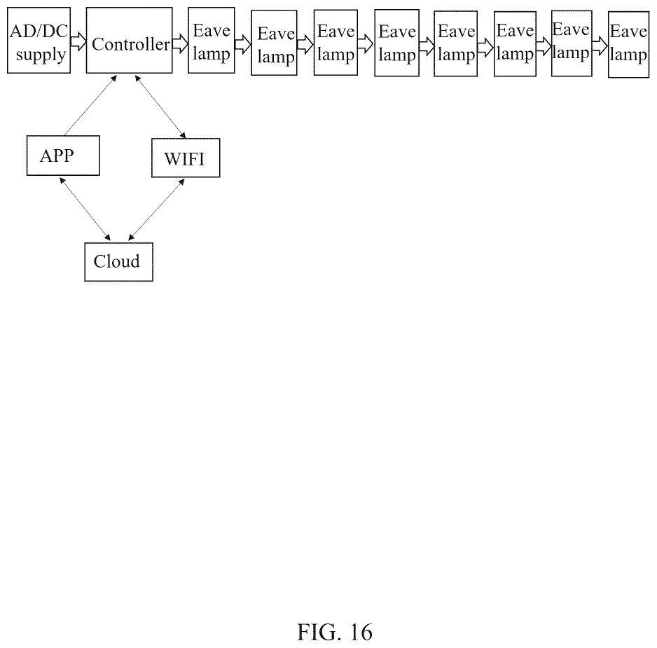

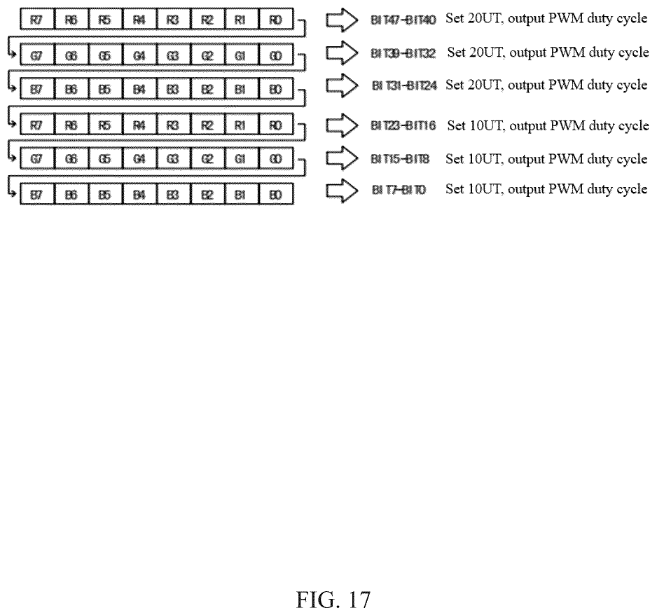

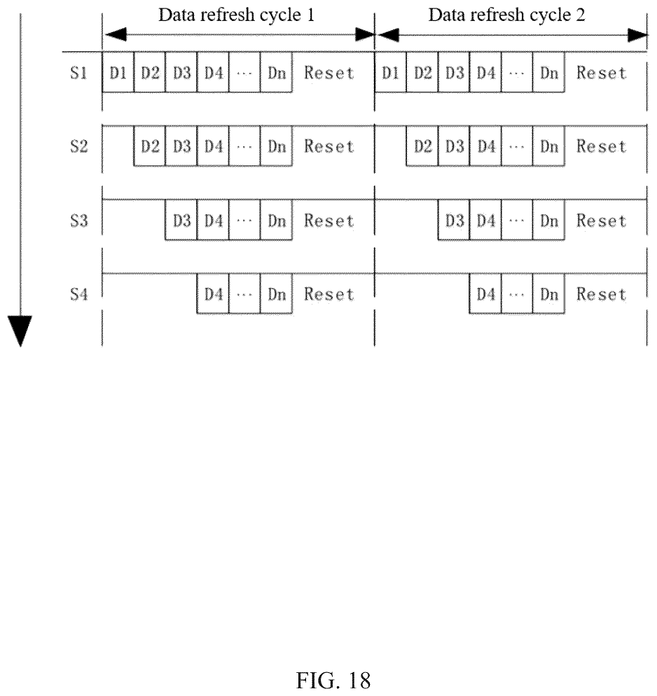

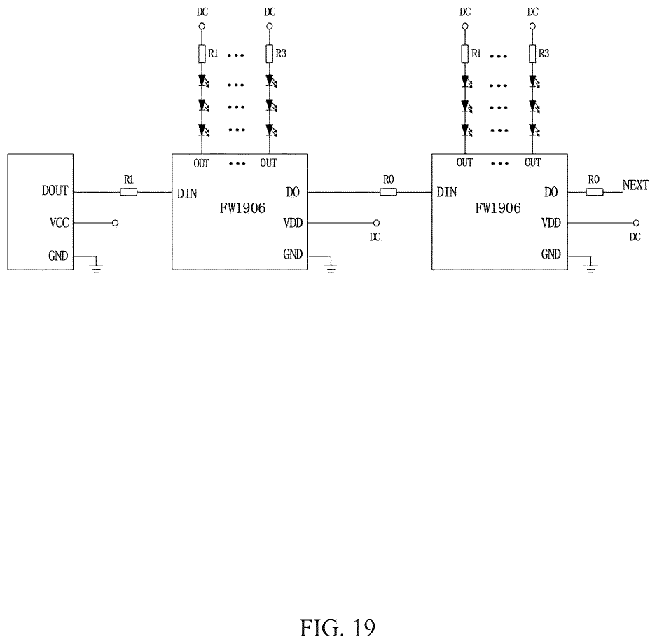

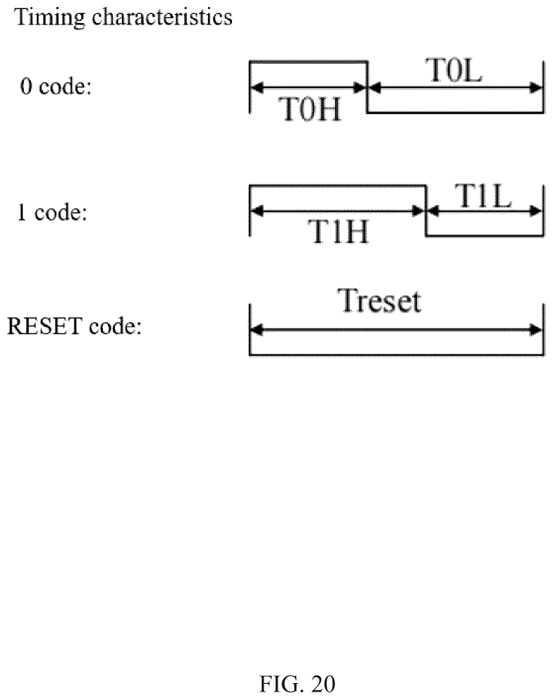

Please further refer to FIGS. 16-20, it can be understood that the control chip 612 can be a 5-channel low-voltage linear constant current drive chip FW1906. FW1906 is a 5-channel low-voltage linear driver chip with a single wire, zero code protocol, which can achieve low voltage constant current turn-on and high output current accuracy. The FW1906 protocol uses a unipolar zero code, and each code must have a low level. Each code in this protocol starts at a high level, and a duration of high level determines whether it is a “0” code or a “1” code.

It can be understood that the control chip 612 is provided with a high-voltage driving module with an OUT port, a zeroing code decoding module, an over temperature protection module, a constant current driving module, and a zeroing code data shaping output module. Each OUTRGBWY has a built-in 5-bit current gain adjustment bit, an output current is set to 1-100 mA, with each current gain adjustment step of 10 mA. The FW1906OUTRGBWY supports 65536 grayscale dimming, and the color adjustment of the lamp is smooth and delicate. The FW1906 chip DIN inputs a standby signal and enters a standby mode, thereby achieving low standby power consumption; and detects DIN input data and automatically exits the standby mode, the FW1906 driver chip also has an over temperature protection function. When an internal temperature reaches an over temperature protection point, the output current is reduced to improve system reliability. The FW1906driver chip protocol uses a unipolar zeroing code, and each code must have a low level. Each code in this protocol starts at a high level, and the duration of the high level determines the “0” or “1” code; FW1906 single chip inputs 80 bits of data, including 16 bits of grayscale data for OUTRGBWY each; at the end of each frame, there are 32 bits of data, including 5 bits of current gain data for OUTRGBWY, 2 bits of standby enable bit 2b′10, and 5 bits of reserved bit. Please refer to FIG. 5 for details. The grayscale data and current gain data are both high-order.

After RESET time, cascaded N chips synchronously refresh the data and output the corresponding RGBWY current.

It can be understood that the light-emitting component 611 can be an RGB (W CW) LED chip packaged in 5050, and each set of light colors in the chip is packaged with 6 strings of warm white light, 6 strings of cool white light, 6 strings of red light, 6 strings of green light, and 6 strings of blue light.

It can be understood that the multi-purpose lamp may also include a controller and a driving power supply. The driving power supply is connected to the controller, and the controller is connected to the connection wire 5.

The driving power supply can be a DC driving power supply, consisting of AC/DC circuits.

It can be understood that the controller can also be connected to a router and connected to an APP through the router, thereby achieving intelligent control of brightness, color, and time of the multi-purpose light through the APP. The router and APP are both connected to a cloud platform for data storage and backup, as well as reading data from the cloud platform.

The router is provided with wireless control modules for WiFi and Bluetooth.

In summary, the present application provides a multi-purpose lamp that can be flexibly installed by a user through the fixing element; the cooperation design of the through hole and the ground plug can transform the multi-purpose lamp into a stake lamp, so that the multi-purpose lamp is no longer solely used on eaves; by a design the lens, the effect of emitting light is enhanced.

The above are only embodiments of the present application and do not limit the scope of the present application. Any equivalent structure or equivalent process transformation made using the content of this specification and drawings, or directly or indirectly applied in other related technical fields, are also included in the protection scope of the present application.

1. A multi-purpose lamp, comprising an upper shell, a lower shell, a reflective cup component, a connection wire, and a control module;
the control module comprises a printed circuit board assembly, PCBA board, and the PCBA board is provided with a light-emitting component and a control chip;
the upper shell is connected to the lower shell, and the control module is located in the upper shell;
the reflective cup component corresponds to the light-emitting component;
the connection wire is connected to the control module and transmits power and signals;
wherein the multi-purpose lamp further comprises a fixing element configured to be L-shaped,
wherein the fixing element is provided with a fixing element clamp block, a fixing hole, a circuit channel, and a heat dissipation hole; the fixing element clamp block is configured to fix the upper shell, the circuit channel is configured to comb the connection wire, the heat dissipation hole is configured for heat dissipation, and the fixing hole is configured to fix the fixing element.

2. The multi-purpose lamp according to claim 1, wherein the upper shell is provided with a reinforcing rib, a positioning hole, and a wire slot;
the lower shell is provided with a positioning column, a wiring trough, and a through hole;
the reflective cup component comprises a reflective cup;
the connection wire comprises an electric wire, a data wire, and a solder pad;
the PCBA board is provided with a positioning groove;
a shape of the PCBA board corresponds to an internal shape of the upper shell; the reinforcing rib is matched with the positioning groove;
the positioning column is matched with the positioning hole to facilitate a connection between the upper shell and the lower shell.

3. The multi-purpose lamp according to claim 1, wherein the multi-purpose lamp is capable of being connected to a router, and the multi-purpose lamp is connected to an APP through the router;
the multi-purpose lamp further comprises a controller and a driving power supply.

4. The multi-purpose lamp according to claim 1, wherein the control chip is provided with a high-voltage driving module with an OUT port, a zeroing code decoding module, an over temperature protection module, a constant current driving module, and a zeroing code data shaping output module;
the control chip is a FW1906 chip;
the light-emitting component is a 5050 packaged RGBCW LED light emitting chip, and the LED light emitting chip is packaged with 6 strings of warm white light, 6 strings of cool white light, 6 strings of red light, 6 strings of green light, and 6 strings of blue light.

5. The multi-purpose lamp according to claim 2, wherein the multi-purpose lamp further comprises a lens and a ground plug,
the ground plug is connected to the lower shell through the through hole; the lens is connected to the upper shell.

6. The multi-purpose lamp according to claim 5, wherein the lens is provided with a transparent part and a lens connection part;
the lens connection part is provided with a connection clamp block; the connection clamp block is configured to connect the upper shell.

7. The multi-purpose lamp according to claim 6, wherein the transparent part is spherical, cylindrical, a star-shape, rectangular, or pumpkin-shape;
the transparent part is provided with a refractive part, and the refractive part is conical in shape;
a surface of the transparent part is coated with a reflective coating, which renders light evenly reflected to the ground.

8-9. (canceled)
